(19) United States
(12) Patent Application Publication
(10) Pub. No.: US 2018/0372680 A1
(43) Pub. Date: Dec. 27, 2018

(54) GEL CASSETTE OPENER

(71) Applicant: Bio-Rad Laboratories, Inc., Hercules, CA (US)

(72) Inventors: Yochanan URI, Givat Ela (IL); Igor KOCHETKOV, Afula (IL); Uri ISSMAN, Haifa (IL); Shai AHARON, Yoqneam (IL)

(21) Appl. No.: 16/013,743

(22) Filed: Jun. 20, 2018

Related U.S. Application Data
(60) Provisional application No. 62/524,902, filed on Jun. 26, 2017.

(51) Int. Cl. G01N 27/447

(52) U.S. Cl. CPC G01N 27/44704

(57) ABSTRACT

Gel cassette opening devices and methods for opening gel cassettes are provided.

### CROSS-REFERENCES TO RELATED APPLICATIONS

This application claims the benefit of U.S. Provisional Application 62/524,902 filed on Jun. 26, 2017, which is hereby incorporated by reference in its entirety.

### BACKGROUND OF THE INVENTION

Western blotting is widely used technique for protein analysis. In the technique, proteins are separated by gel electrophoresis, are transferred onto a hydrophobic membrane and are then visualized using various labeling method.

To perform western blot analysis of protein bands separated by gel electrophoresis, the user manually opens the gel cassette, gently lifts the fragile gel and places the gel on a blotting membrane. During the process of placing the gel on the blotting membrane, the gel may be damaged by tearing, warping, and/or stretching. Once the gel is placed on the membrane, the user gently aligns the gel with the membrane edges. The user then places the membrane with the gel in the western blotting apparatus for the transfer step. Thus, manual removal of the gel from the cassette and placement of the gel on the membrane without damaging the gel is challenging and requires a practiced user with technical skill.

### BRIEF SUMMARY OF THE INVENTION

Provided herein are devices for opening gel cassette and methods of using such devices.

In an embodiment, a gel cassette opener comprises a drawer slidably mounted in a housing and movable in a sliding direction between a first position in which at least a portion of the drawer extends outside a front opening of the housing, and a second position in which the drawer is contained within the housing, wherein the drawer comprises two elongated support rails for supporting a gel cassette and a membrane in a horizontal side-by-side position; a first and second vacuum chuck movably mounted in the housing, each chuck comprising a planar support having a vacuum aperture and a fluid aperture, wherein the first vacuum chuck is located below the plane of the drawer and the second vacuum chuck is located above the plane of the drawer; a vacuum source operably connected to the vacuum aperture in each of the vacuum chucks; a fluid (e.g., air, nitrogen, water, or oil) source operably connected to the fluid aperture in each of the vacuum chucks; and control circuitry for controlling operation of the gel cassette opener.

In some embodiments, the gel cassette opener further comprises a third vacuum chuck located below the plane of the drawer and movably mounted within the housing. In some embodiments, the gel cassette opener further comprises a fourth vacuum chuck located above the plane of the drawer and movably mounted within the housing. In certain embodiments, the fourth vacuum chuck comprises a recess sized such that the margins of the gel rest outside the recess when the gel is vacuum gripped by the fourth vacuum chuck. In certain embodiments, the margins are about 1-5 millimeters wide. In some embodiments, the recess has a depth of about 0.25-0.75 millimeters. In some embodiments, the recess has a depth of about 0.5 millimeters. In some embodiments, the first, second, third and/or fourth vacuum chucks are moveable in an X, Y, and/or Z direction. In certain embodiments, the vacuum source is connected to the vacuum aperture by a vacuum channel within each of the vacuum chucks. In some embodiments, the air or water source is connected to the air aperture by an air channel within each of the vacuum chucks.

In an embodiment, a method of opening a gel cassette comprises providing a gel cassette comprising a gel sandwiched in between an upper wall and a lower wall; removing the gel from the upper wall while supporting the gel with the lower wall; and vacuum gripping an exposed side of the gel while removing the gel from the lower wall. In some embodiments, the method further comprises moving the gel to a position above a membrane and placing the gel on the membrane. In some embodiments, the gel is removed from the upper wall by injecting a fluid (e.g., air, nitrogen, water, or oil) through a first hole in the upper wall. In some embodiments, the gel is removed from the lower wall by injecting the fluid through a second hole in the lower wall.

In some embodiments, the method of opening a gel cassette comprises providing a gel cassette comprising a gel sandwiched in between a lower wall and an upper wall; removing the gel from the lower wall while supporting the gel with the upper wall; mating an exposed side of the gel to a membrane; and removing the gel from the upper wall while the gel remains mated to the membrane. In some embodiments, the gel is removed from the lower wall by injecting a fluid through a second hole in the lower wall. In certain embodiments, the gel is removed from the upper wall by injecting the fluid through a first hole in the upper wall. In some embodiments, the method further comprises applying a vacuum to the gel from below while injecting the fluid through the first hole in the upper wall.

In certain embodiments, a plug is removed from the first hole and the second hole prior to injecting fluid through each of the first and second holes. In some embodiments, the first hole is located substantially in the center of the upper wall and the second hole is located substantially in the center of the lower wall. In some embodiments, the membrane is attached to a frame. In some embodiments, the frame comprises raised sharp inner edges that cut through the gel when pressed against the gel. In certain embodiments, the upper or lower wall of the gel cassette comprises a groove on an inner surface contacting the gel and the groove runs in a continuous line parallel to the edges of the upper or lower wall. In some embodiments, the upper and lower walls are not attached to each other.

### BRIEF DESCRIPTION OF THE DRAWINGS

FIG. 1 is a schematic perspective side view of a gel cassette opener according to an embodiment of the invention. To more easily view the components, the housing has been removed in this and all subsequent gel cassette opener figures.

FIGS. 2A-2N are schematic perspective and cross-sectional side views of the gel cassette opener of FIG. 1 in various stages of operation.

FIG. 3 is a schematic perspective side view of a gel cassette opener according to another embodiment of the invention.

FIGS. 4A-4K are schematic perspective and cross-sectional side views of the gel cassette opener of FIG. 3 in various stages of operation.

FIGS. 5A-SI are schematic cross-sectional side views of a gel cassette opener according to another embodiment of the invention. The device is shown in various stages of operation.

FIG. 6 is a schematic perspective view of a vacuum chuck according to an embodiment of the invention in which the vacuum chuck comprises a recess for vacuum gripping a portion of a gel in a process illustrated in FIGS. 2A-2N. The view is from a surface of the vacuum chuck that comprises the recess.

FIGS. 7A-7C are various views of a gel cassette that can be opened by openers according to embodiments of the invention. FIG. 7A is a schematic cross-sectional side view through air injection holes in each wall of a gel cassette. FIG. 7B is a perspective view of the cross-section shown in FIG. 7A. FIG. 7C is a schematic perspective view of a gel cassette with transparent walls and showing an air injection hole substantially in the center of each wall. In each of views 7A-7C, air hole plugs have been removed.

FIG. 8 is a schematic cross-sectional side view through a plugged air hole in a cassette wall of the gel cassette shown in FIGS. 7A-7C.

FIG. 9 is a photograph of a cassette with a gel after a lower wall has been removed. A rectangular groove runs parallel to the edges of the lower wall of the cassette. The gel on the upper wall has a ridge corresponding to the groove in the lower wall.

FIG. 10 is a schematic perspective view of a frame for a membrane that may be used in methods according to embodiments of the invention. The frame has raised sharp inner edges that can cut the gel when pressed against the gel.

FIGS. 11A and 11B are photographs of the frame without the membrane attached (FIG. 11A) and with the membrane attached to the frame (FIG. 11B). FIG. 11B shows a gel inside the frame on the membrane after the gel has been removed from an upper cassette wall in the method illustrated in FIGS. 4A-4K.

### DETAILED DESCRIPTION OF THE INVENTION

Described herein are automated gel cassette openers and methods of using such devices. Gel cassette openers have been discovered that are “hands-off” and automatically remove each wall of the gel cassette while supporting the delicate gel. The cassette opener can be used as a stand-alone system or as part of a western blotting work flow.

As used in this specification and the appended claims, the singular forms “a”, “an”, and “the” include plural referents unless the content clearly dictates otherwise. As used herein, the term “about” refers to the recited number and any value within 10% of the recited number. Thus, “about 5” refers to any value between 4.5 and 5.5, including 4.5 and 5.5.

### I. Devices

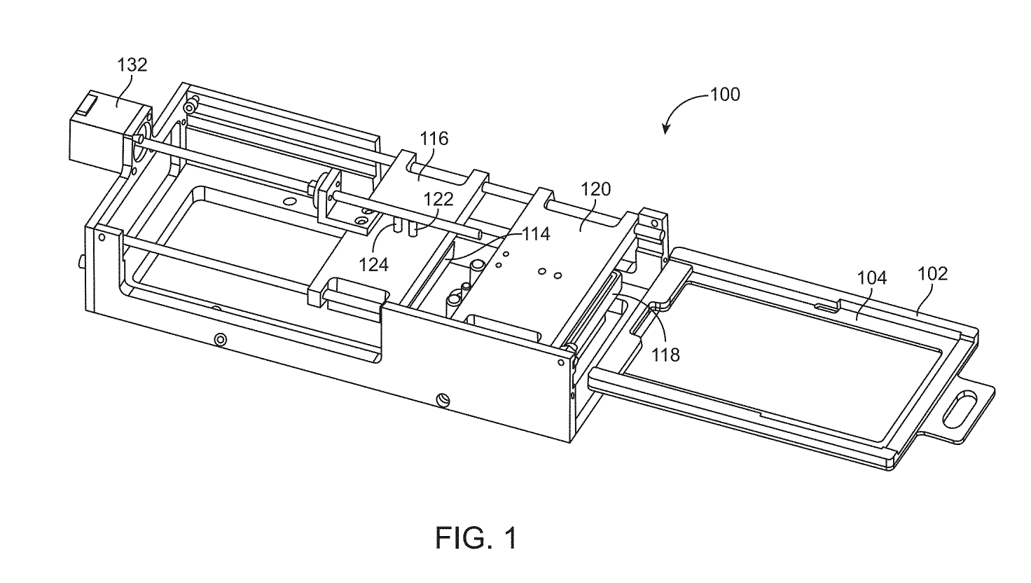

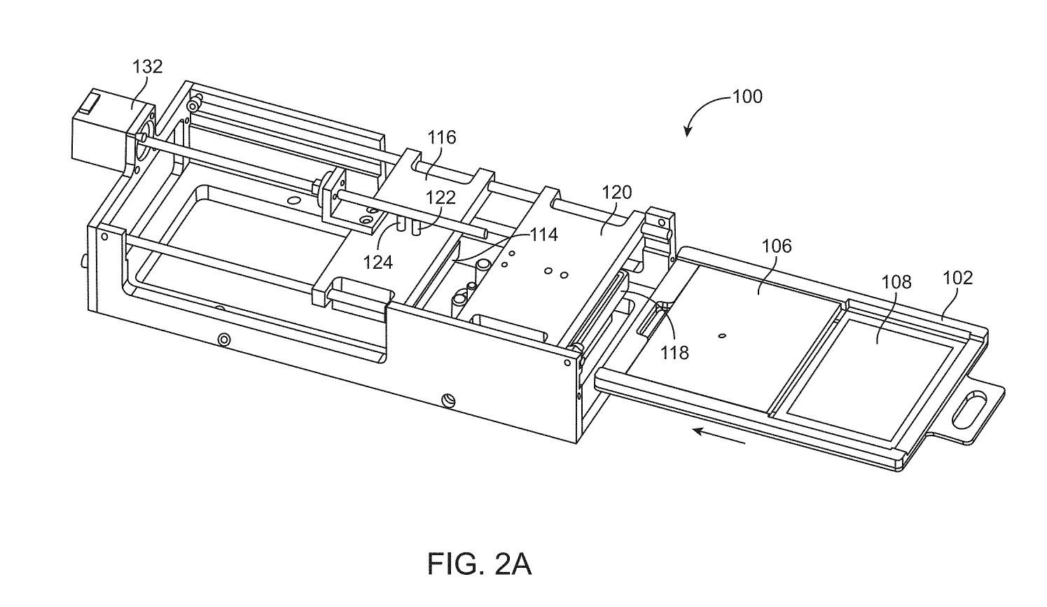

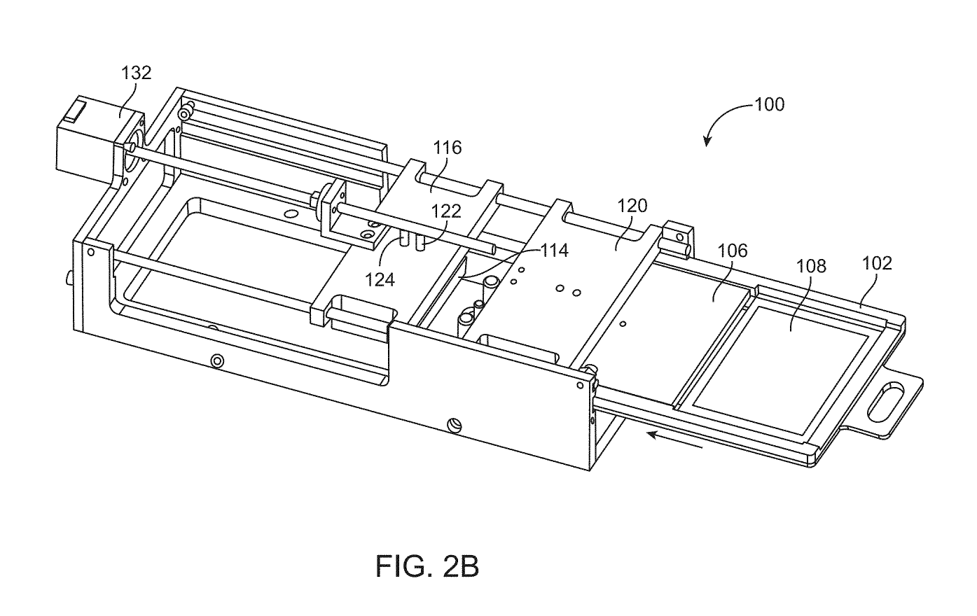

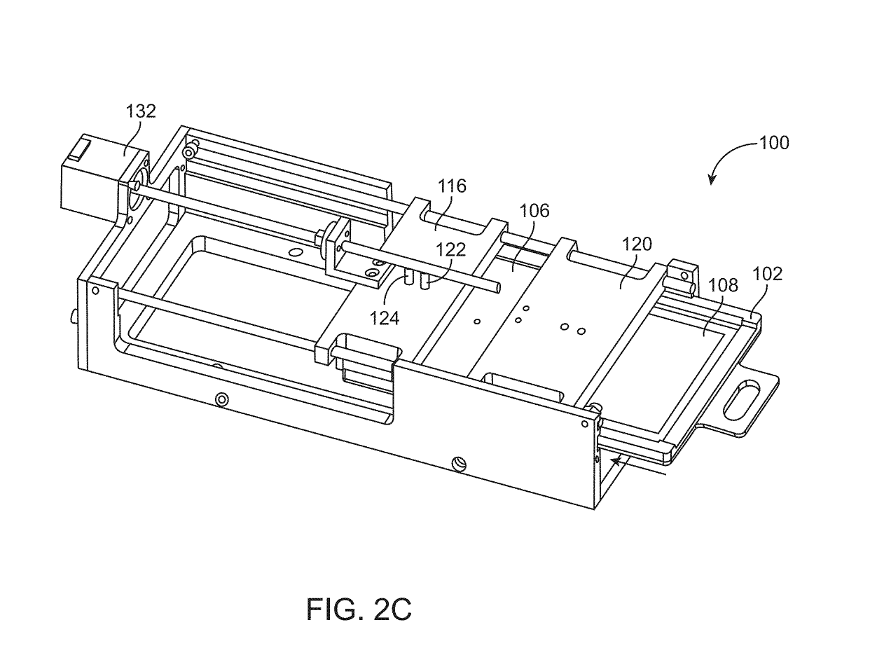

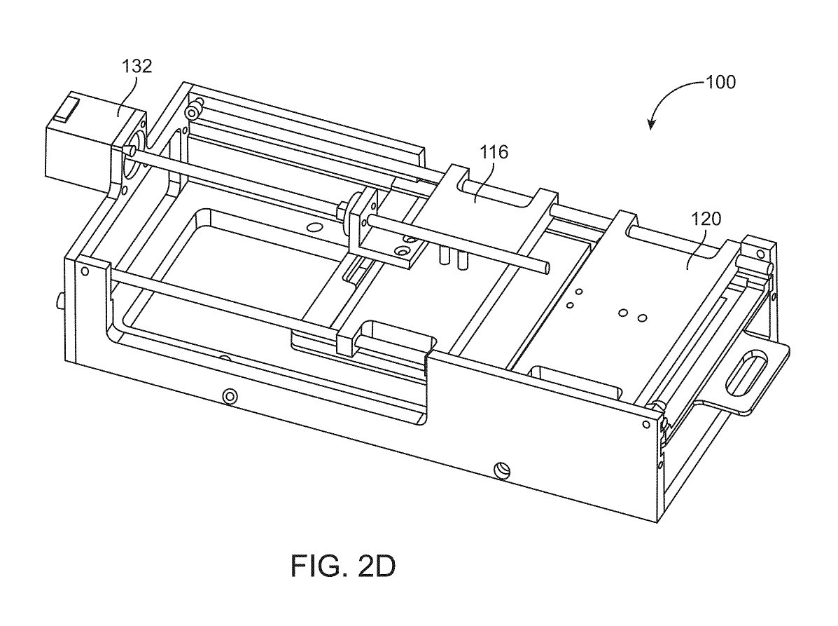

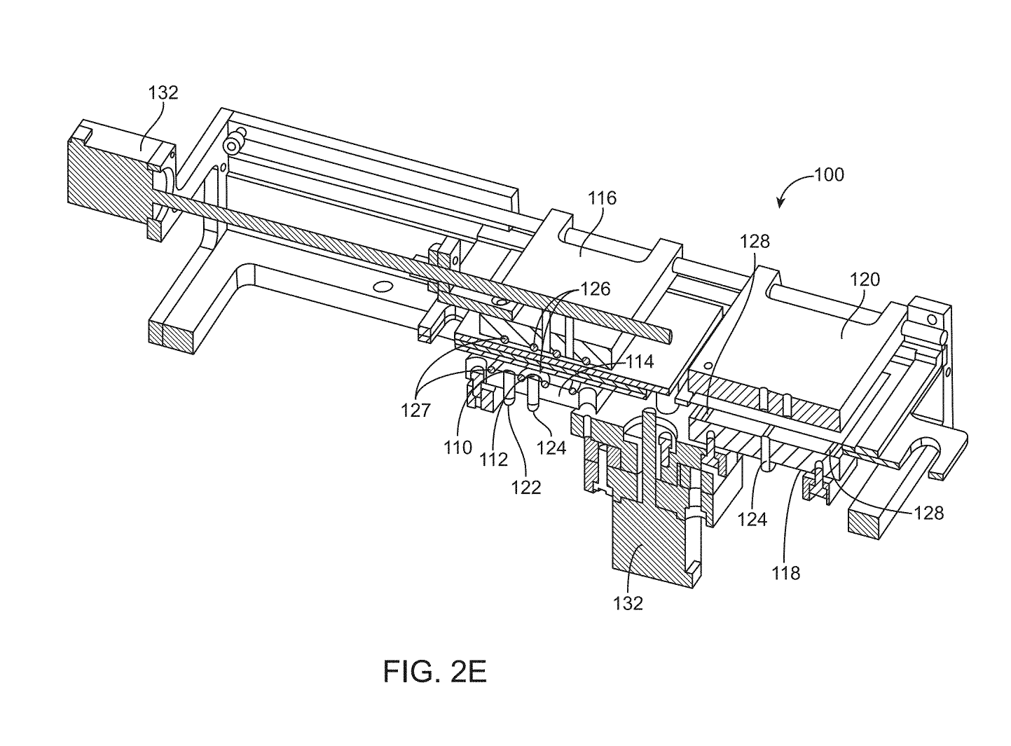

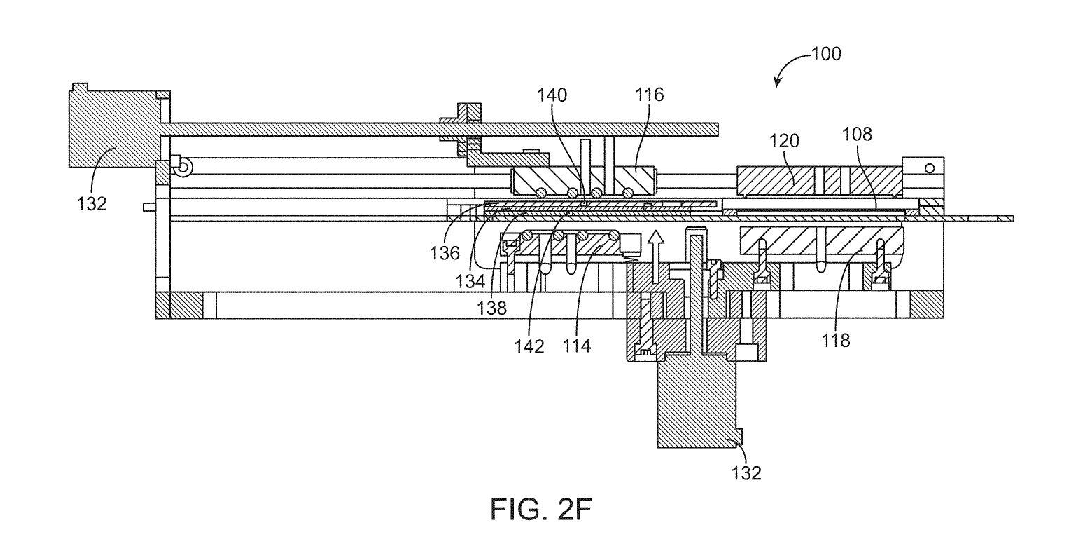

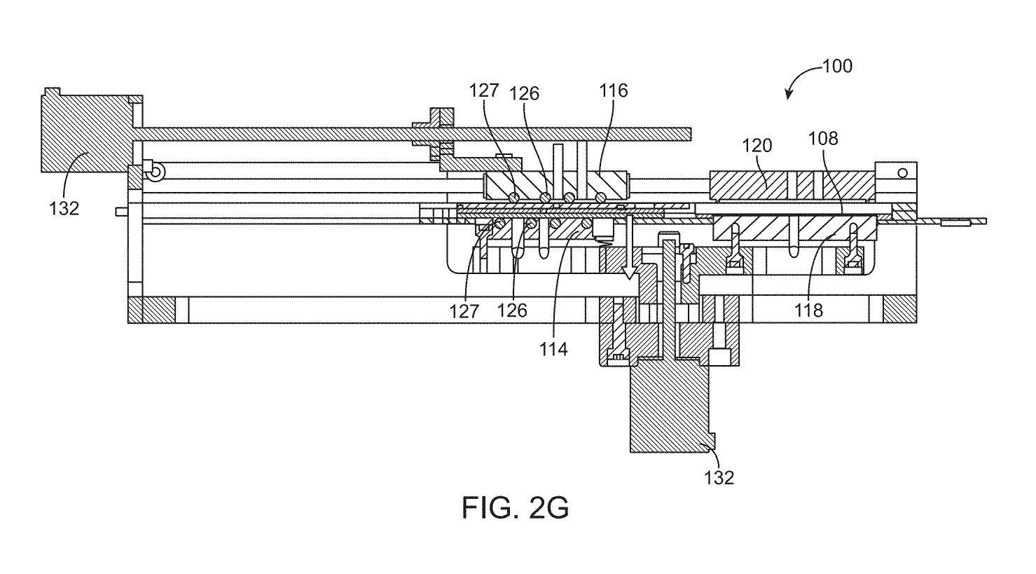

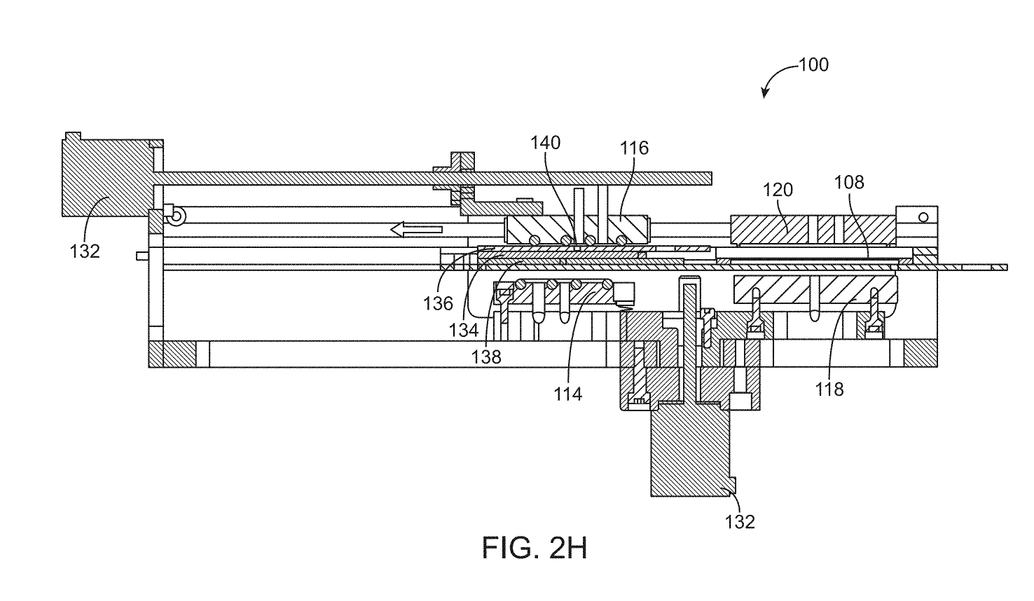

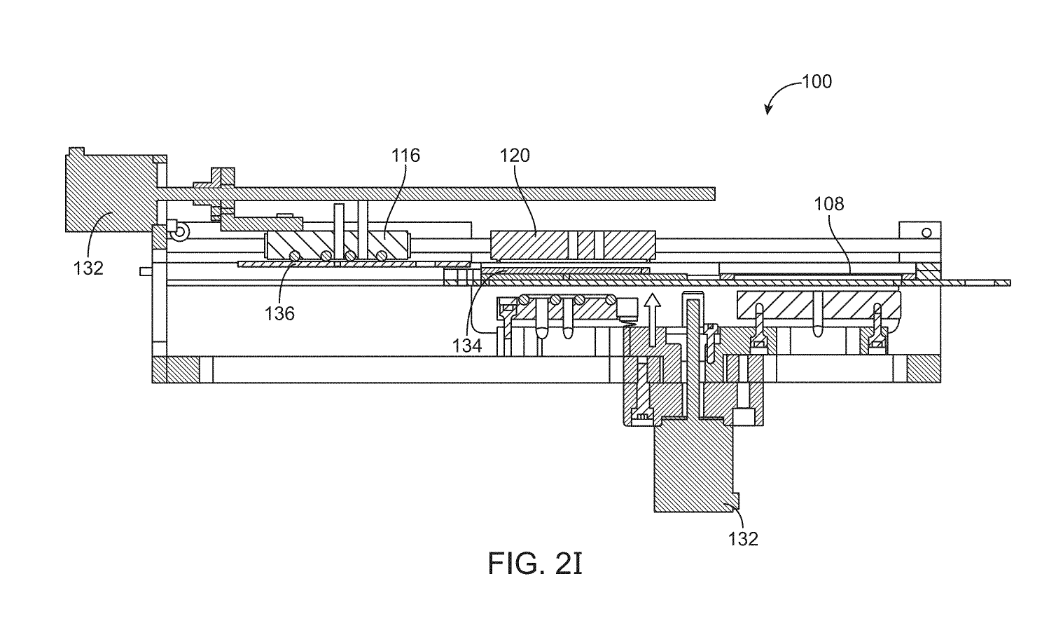

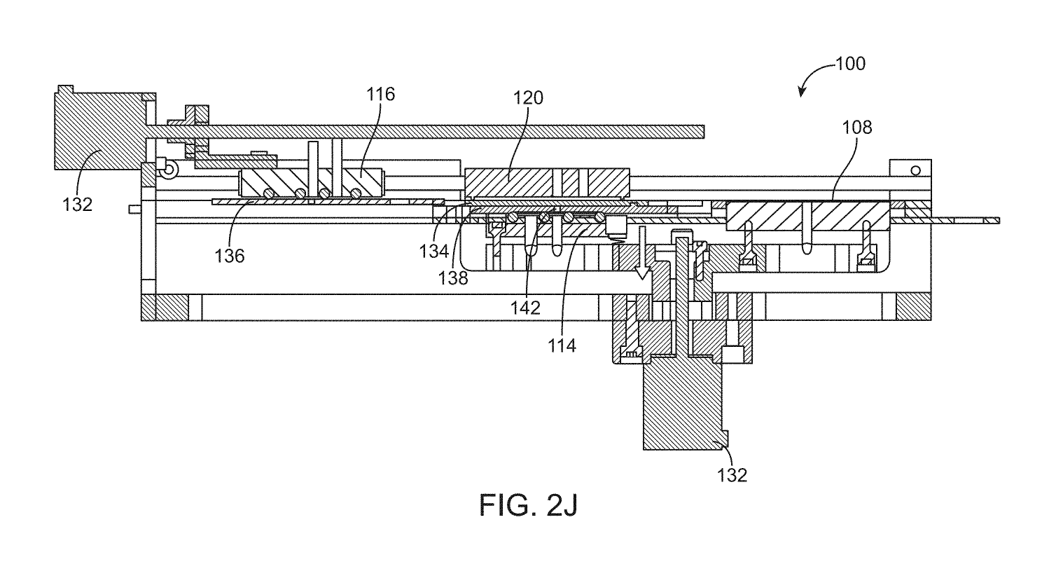

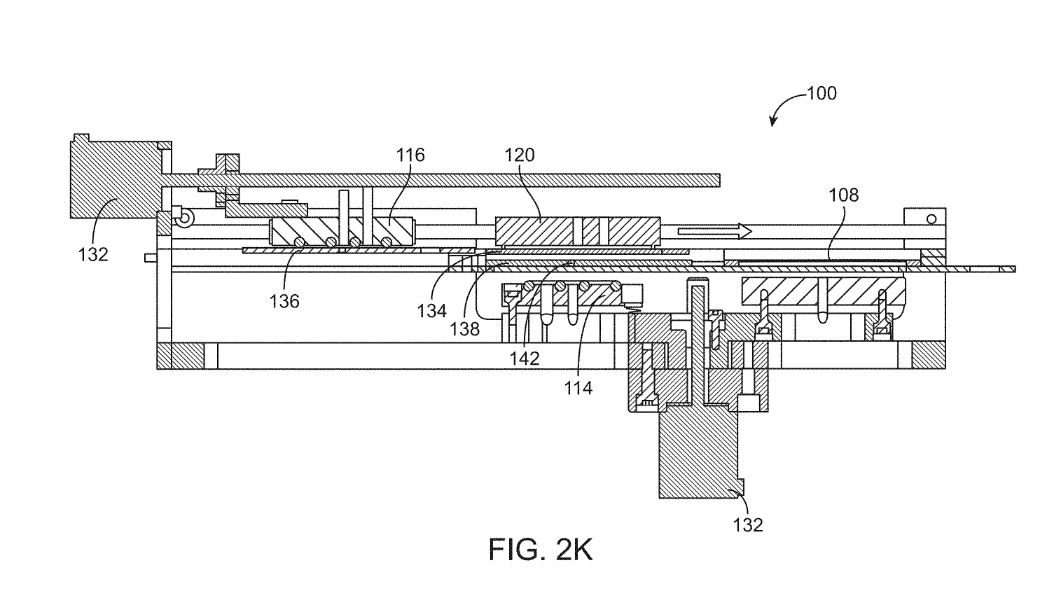

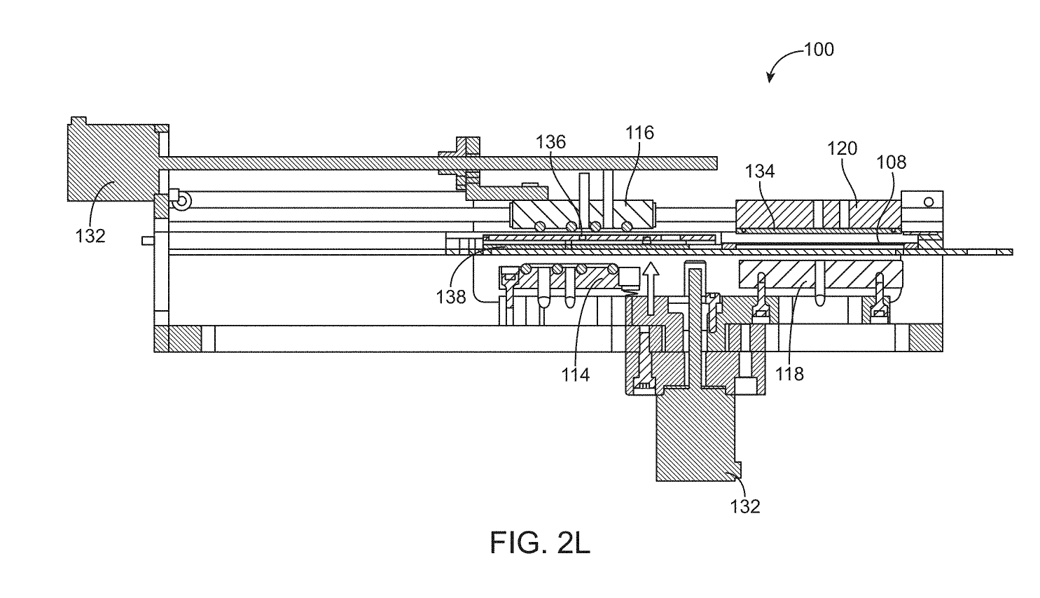

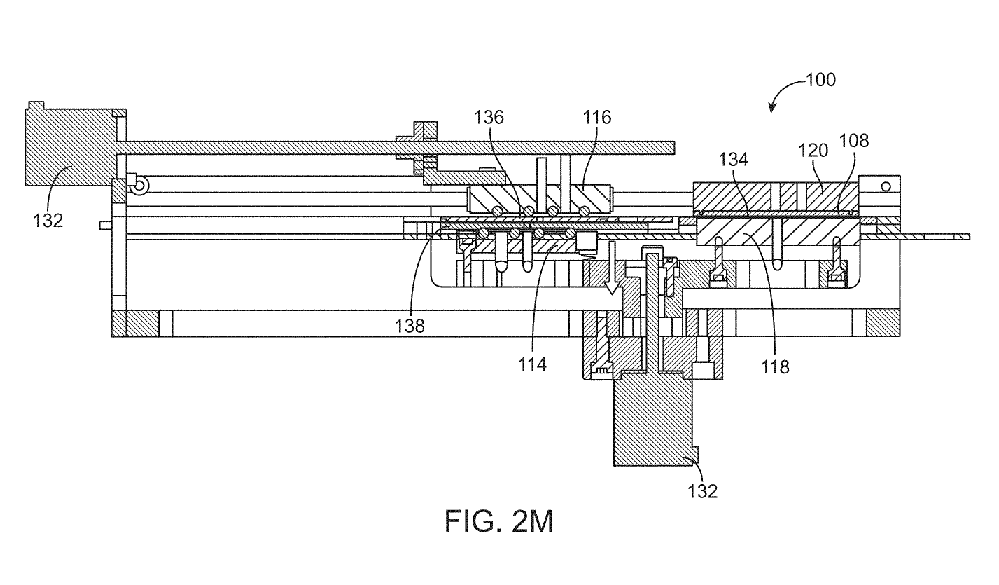

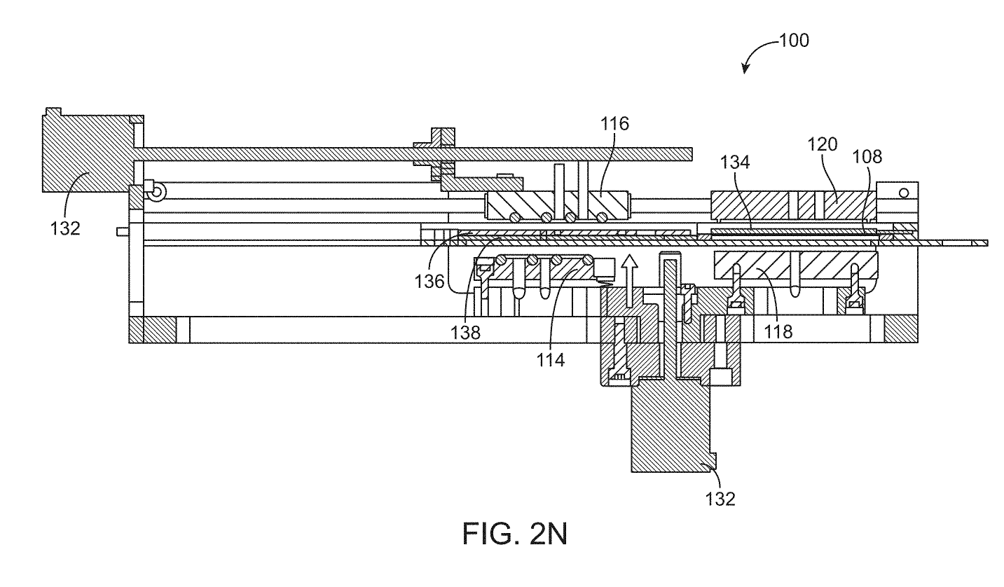

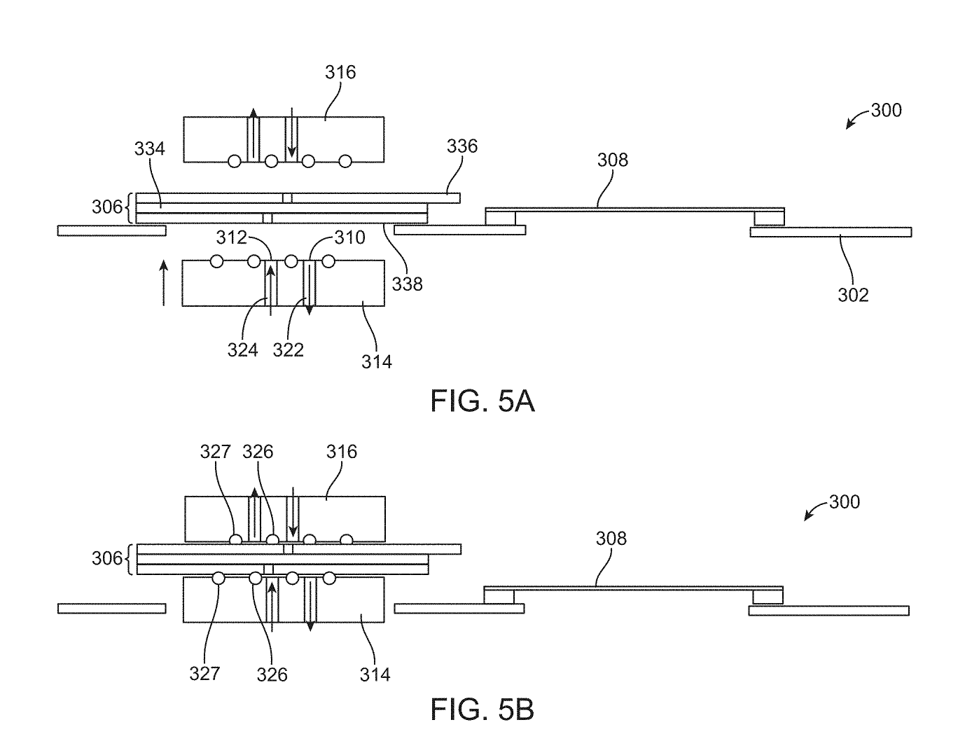

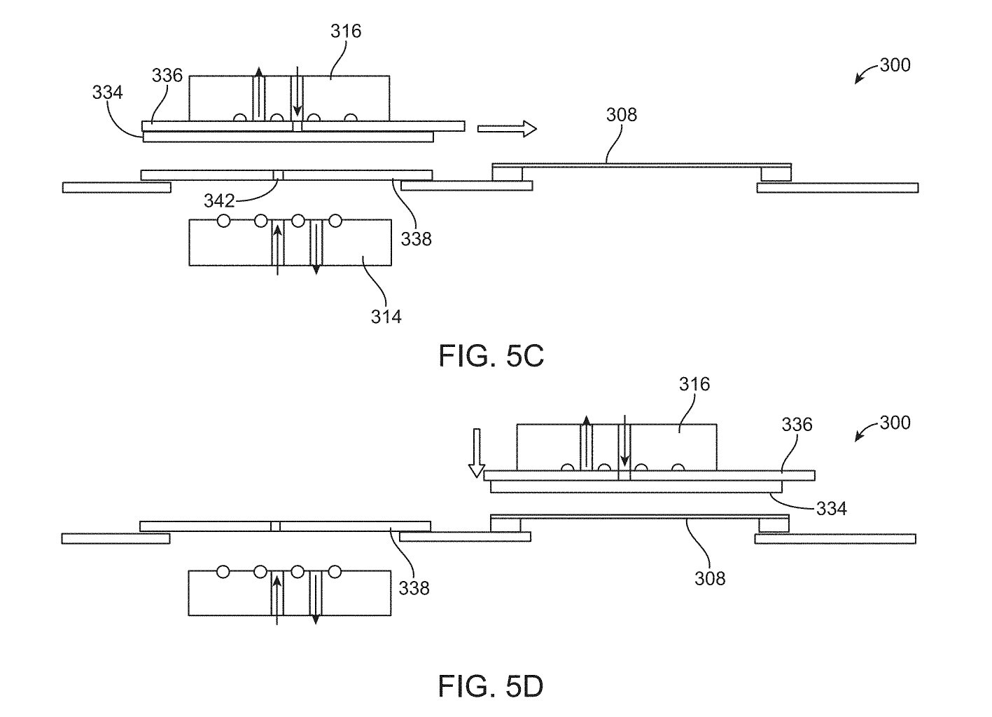

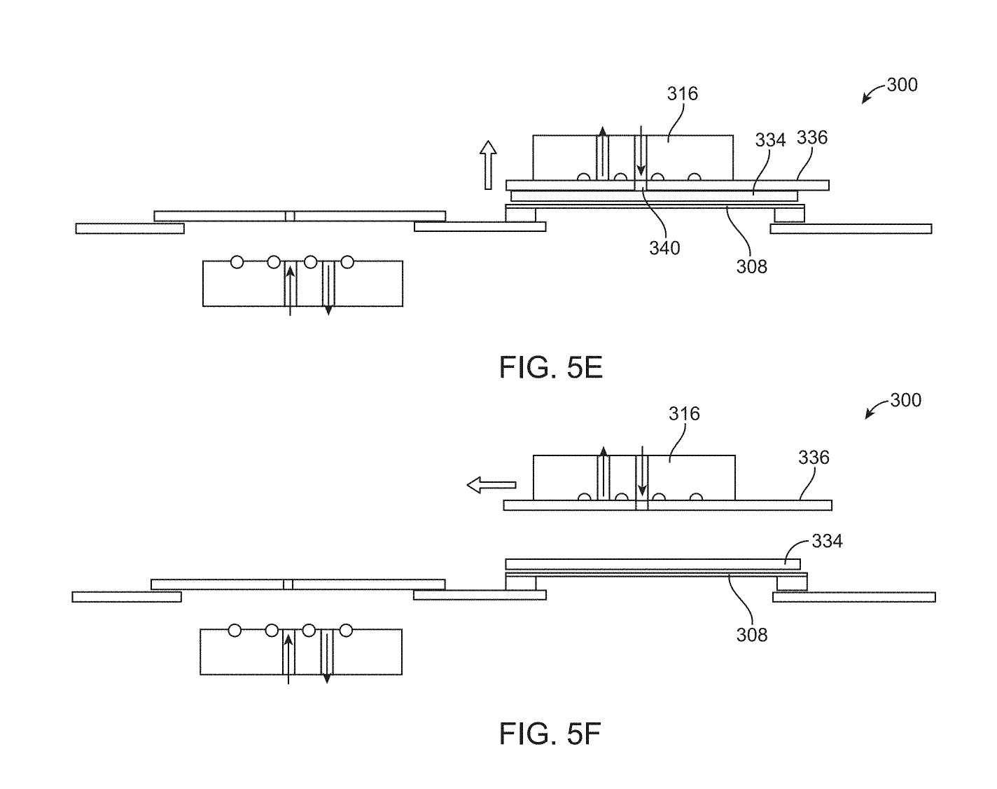

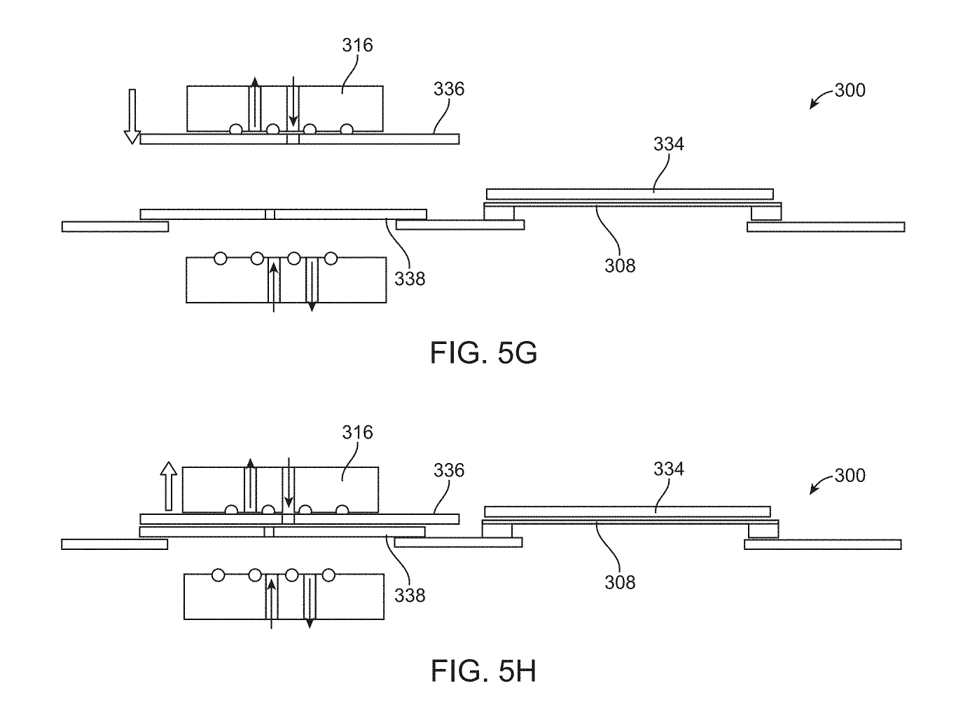

FIGS. 1-5I illustrate embodiments of devices for opening gel cassettes. In an embodiment, a gel cassette opener 100, 200, 300 comprises a drawer 102, 202, 302 slidably mounted in a housing and movable in a sliding direction between a first position in which at least a portion of the drawer extends outside a front opening of the housing, and a second position in which the drawer is contained within the housing. The drawer 102, 202, 302 comprises two elongated support rails 104, 204, 304 for supporting a gel cassette 106, 206, 306 and a membrane 108, 208, 308 in a horizontal side-by-side position. The opener 100, 200, 300 also comprises at least two vacuum chucks movably mounted in the housing. Each chuck comprises a planar support having a vacuum aperture 110, 210, 310 and a fluid aperture 112, 212, 312. In an embodiment, a first vacuum chuck 114, 214, 314 is located below the plane of the drawer and a second vacuum chuck 116, 216, 316 is located above the plane of the drawer (FIGS. 5A-5I). In certain embodiments, the cassette opener further comprises a third vacuum chuck 118, 218 located below the plane of the drawer and movably mounted within the housing (FIGS. 2E-4K). In some embodiments, the cassette opener further comprises a fourth vacuum chuck 120 located above the plane of the drawer and movably mounted within the housing (FIGS. 1-2N).

A vacuum source is operably connected to the vacuum aperture 110, 210, 310 in each of the vacuum chucks. In some embodiments, the vacuum source is connected to the vacuum aperture by a vacuum channel 122, 222, 322 within each of the vacuum chucks. In certain embodiments, the vacuum channel runs from an upper surface of the vacuum chuck to a lower surface of the vacuum chuck. A fluid (e.g., air, nitrogen, water, or oil) source is also operably connected to the fluid aperture 112, 212, 312 in one or more of the vacuum chucks. In some embodiments, the fluid source is connected to the fluid aperture 112, 212, 312 by a fluid channel 124, 224, 324 within one or more of the vacuum chucks. In some embodiments, the fluid channel runs from the upper surface to the lower surface of the vacuum chuck. The vacuum source and the fluid source can be connected to the chucks by, for example, flexible tubing and can be controlled by valves. The cassette opener also has control circuitry for controlling operation of the gel cassette opener.

In some embodiments, the first and second vacuum chucks comprise an inner o-ring 126, 226, 326 and an outer o-ring 127, 227, 327 each sitting in a depression on the surface of the chuck that contacts a cassette wall. The o-rings mate with the cassette wall. The area between the inner and outer o-rings is vacuumed to grip the wall. The area inside the inner o-ring 126, 226, 326 is pressurized to inject fluid through the hole in the cassette wall to separate the gel from the wall. In some embodiments, other types of elastic seals (e.g., bellow suction caps or vacuum pads) can be used instead of o-rings to facilitate gripping an uneven surface.

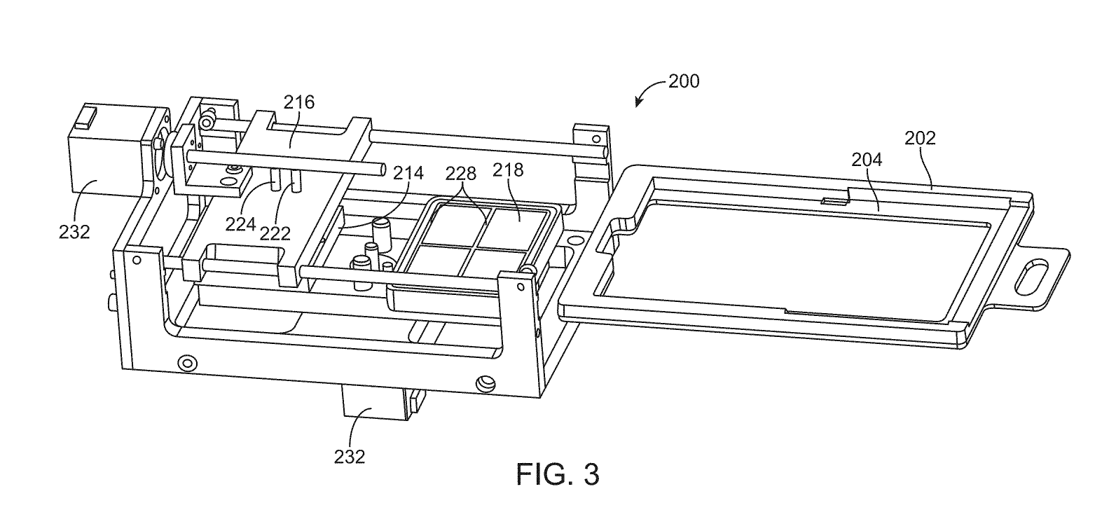

In certain embodiments, the third chuck 118, 218 comprises raised edges that mate with the membrane and press against the edges of the gel. Referring to FIGS. 2E and FIG. 3, the third chuck can also have grooves 128, 228 on the surface that mate with the membrane 108, 208. The grooves 128, 228 can be in any pattern (e.g., squares, circles, etc.). The grooves 128, 228 are connected to the vacuum aperture and assist in applying vacuum evenly across the membrane. In some embodiments, the grooves 128, 228 run along the perimeter of the third chuck 118, 218 upper surface and intersect through the middle of the upper surface.

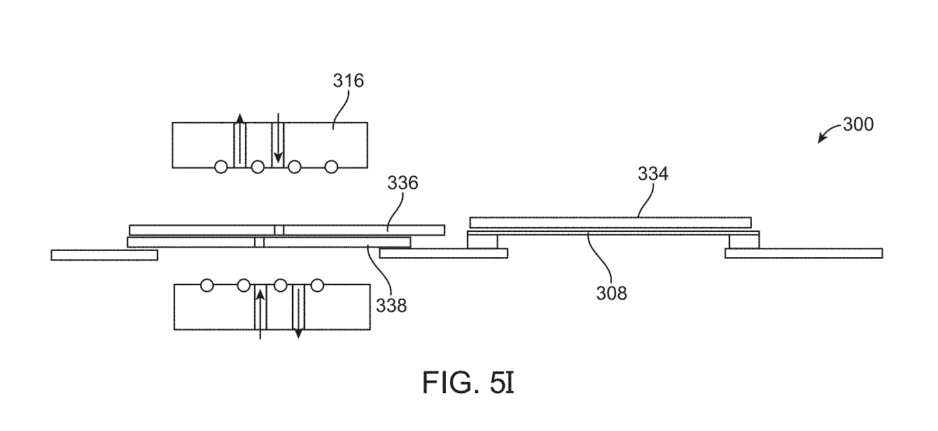

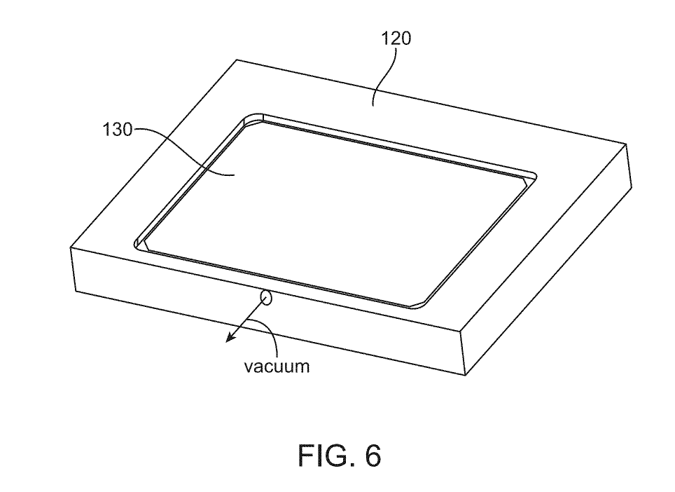

In embodiments of the cassette opener having a fourth vacuum chuck 120, the fourth vacuum chuck 120 can comprise a recess 130 sized such that the margins of the gel rest outside the recess when the fourth vacuum chuck is vacuum gripping the gel (FIG. 6). In certain embodiments, the recess is sized such that margins about 1-5 millimeter wide rests outside the recess when the fourth vacuum chuck is vacuum gripping the gel. In some embodiments, the recess 130 has a depth of about 0.25-0.75 millimeters. In certain embodiments, the recess has a depth of about 0.5 millimeters.

In some embodiments, the first, second, third and/or fourth vacuum chucks can move in an X, Y, and/or Z direction. In some embodiments, one or more vacuum chucks located below the plane of the drawer can move in the Z direction and one or more vacuum chucks located above the plane of the drawer can move in the X direction (FIGS. 1-4I). In certain embodiments, the vacuum chucks can move in the X and Z direction (FIGS. 5A-5I).

In some embodiments, the vacuum chucks are each driven by a motor 132, 232 (FIGS. 1-4K). In embodiments in which two vacuum chucks are positioned above and/or below the plane of the drawer, the vacuum chucks can move together or independently.

The drawer of the cassette opener 100, 200, 300 can be sized to hold a single mini or midi-sized gel cassette and membrane.

### II. Methods

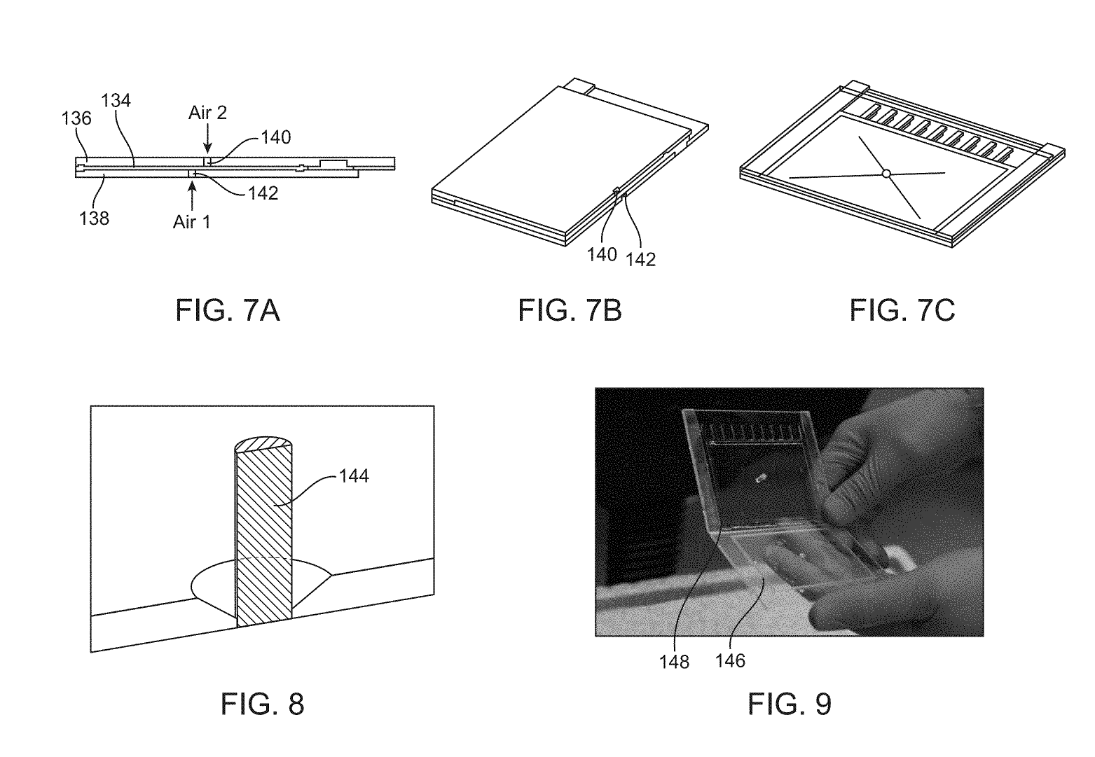

Provided are methods of opening gel cassettes using the devices described herein. In an embodiment, the method comprises providing a gel cassette comprising a gel 134, 234, 334 sandwiched in between an upper wall 136, 236, 336 and a lower wall 138, 238, 338. In some embodiments, the lower and upper walls of the cassette are not attached to each other. In certain embodiments, the lower and upper walls are sealed with a face seal and external clips that hold the two walls together. The upper wall 136, 236, 336 of the cassette has a first hole 140, 240, 340 therein and the lower wall 138, 238, 338 has a second hole 142, 242, 342 therein. In some embodiments, the first and second holes are located substantially in the center of the first and second walls, respectively (FIGS. 7A-7C). Each hole can be plugged with a removable plug 144 (FIG. 8). The plugs are removed prior to opening the cassette. Also prior to opening the cassette, the gel 134, 234, 334 is subject to polyacrylamide gel electrophoresis which separates biological molecules (e.g., proteins or nucleic acids) into bands based on their electrophoretic mobility. The electrophoretic mobility is a function of molecular weight, charge, and conformation of the molecule.

In certain embodiments, the lower or upper wall of the gel cassette comprises a shallow groove 146 on an inner surface contacting the gel and the groove 146 runs in a continuous line parallel to the edges of the lower or upper wall (FIG. 9). In some embodiments, the groove 146 is about 0.1-1 millimeters in depth. In some embodiments, the groove 146 is about 0.5 millimeters in depth. During casting of the gel, the gel fills this groove, creating a ridge 148 in the gel. The ridge 148 in the gel acts as an obstruction to air flow such that when air is injected through a hole in the wall, the air spreads over substantially the entire area of the gel before leaking out through the edges. This facilitates the separation of the gel from the cassette wall.

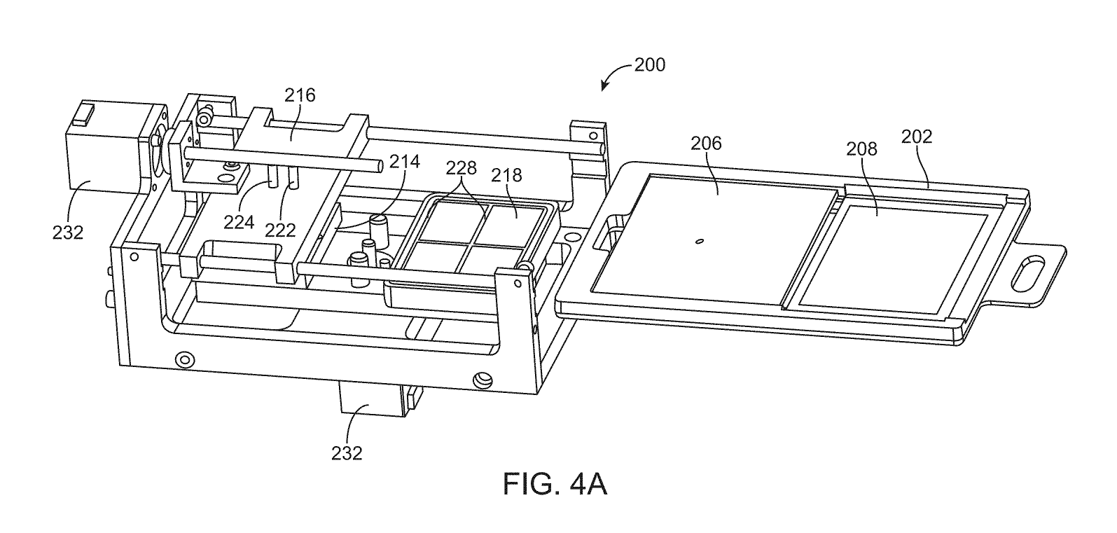

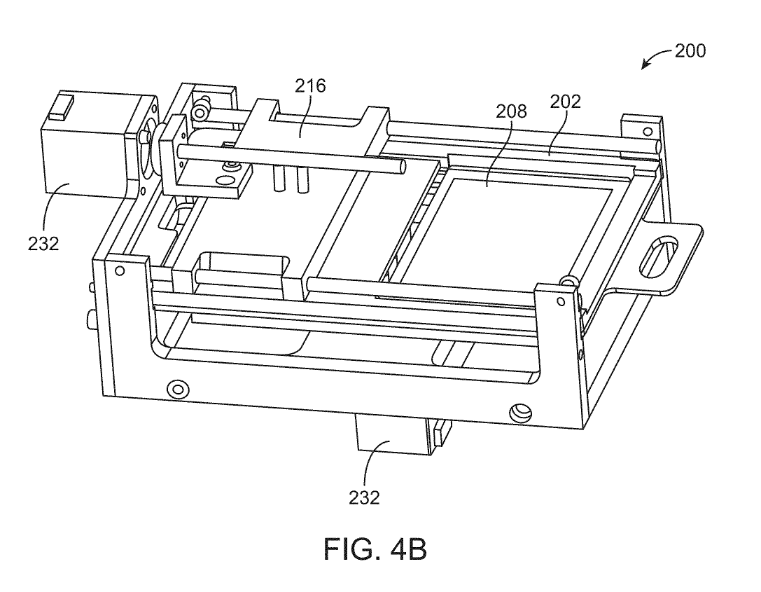

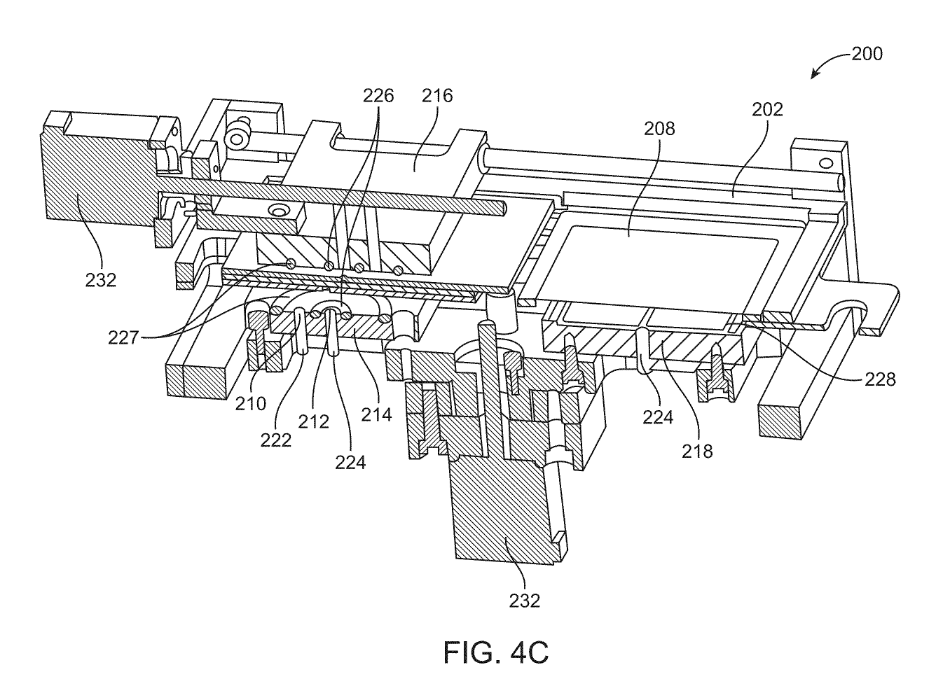

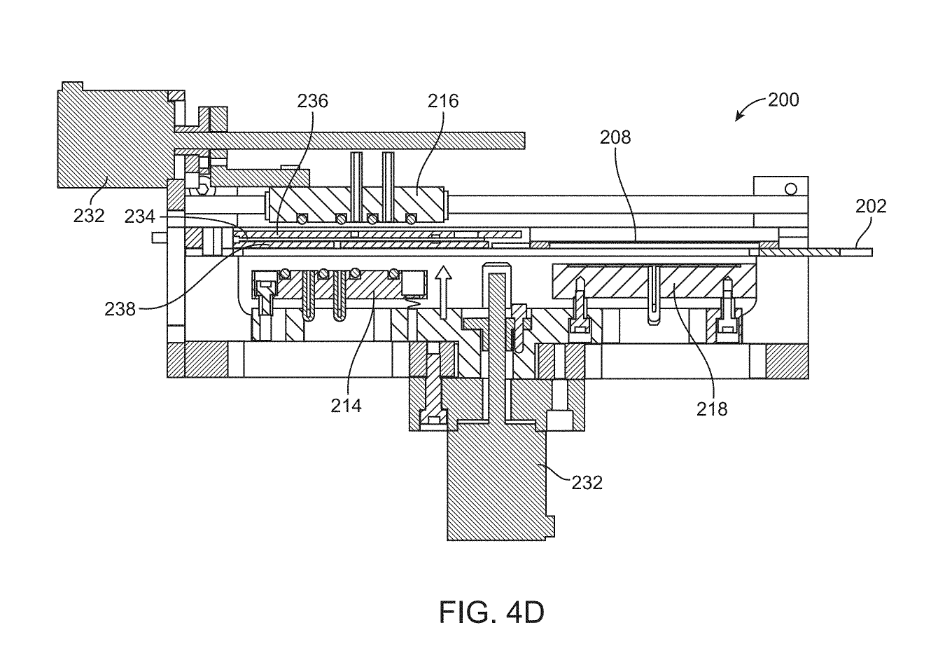

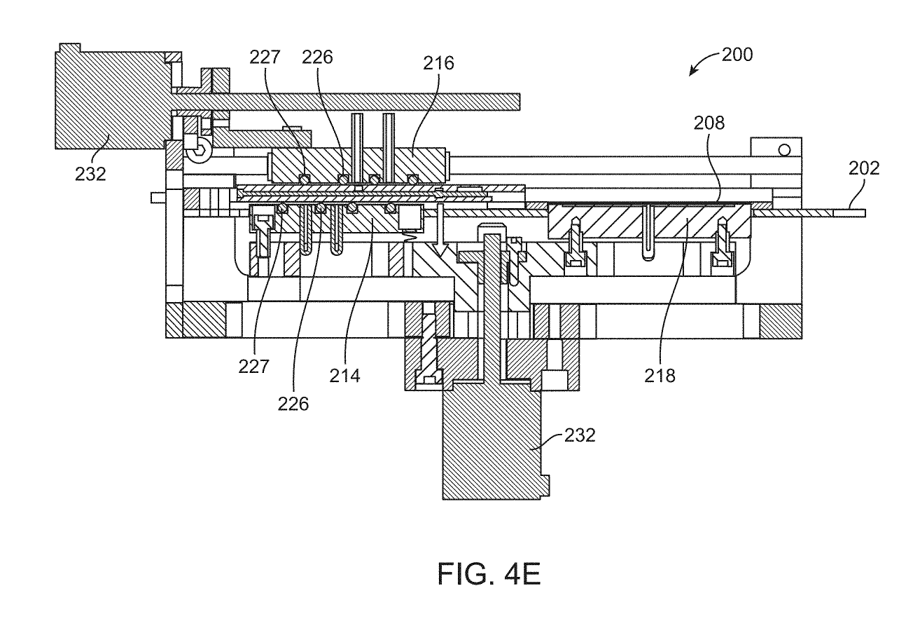

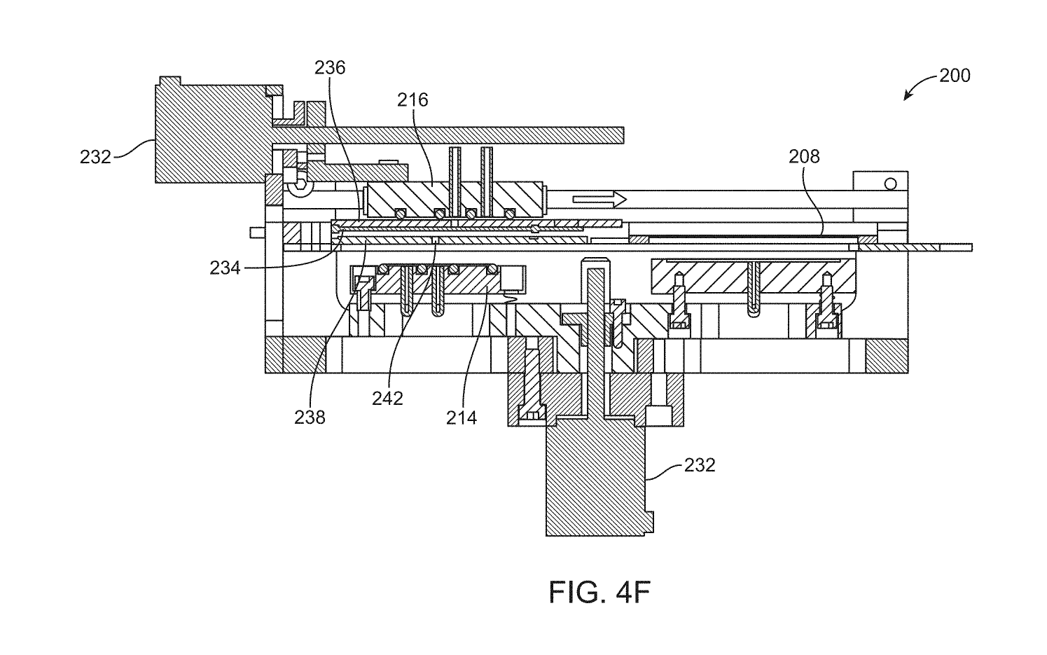

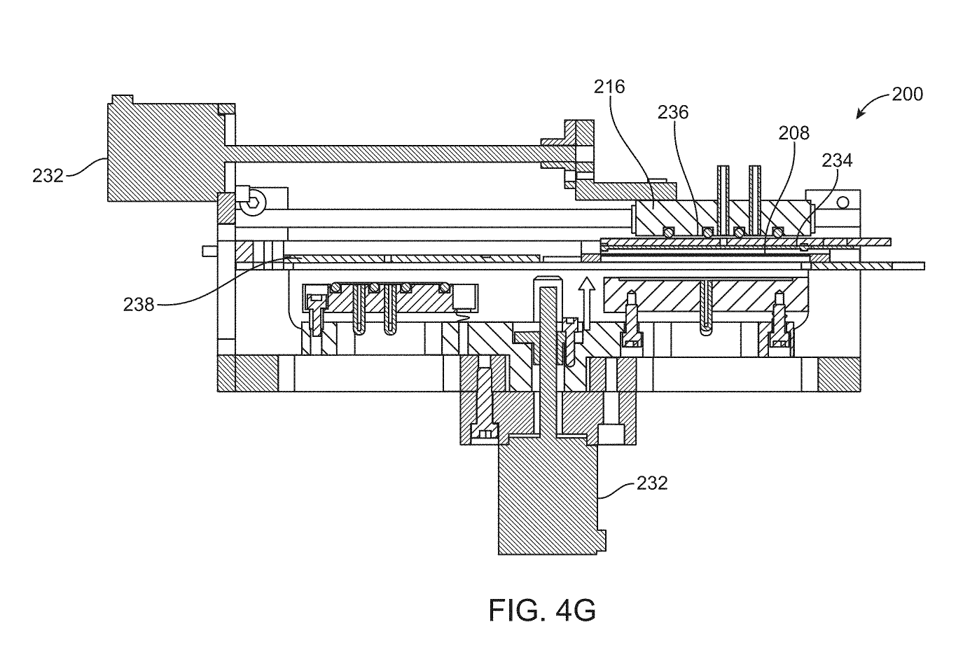

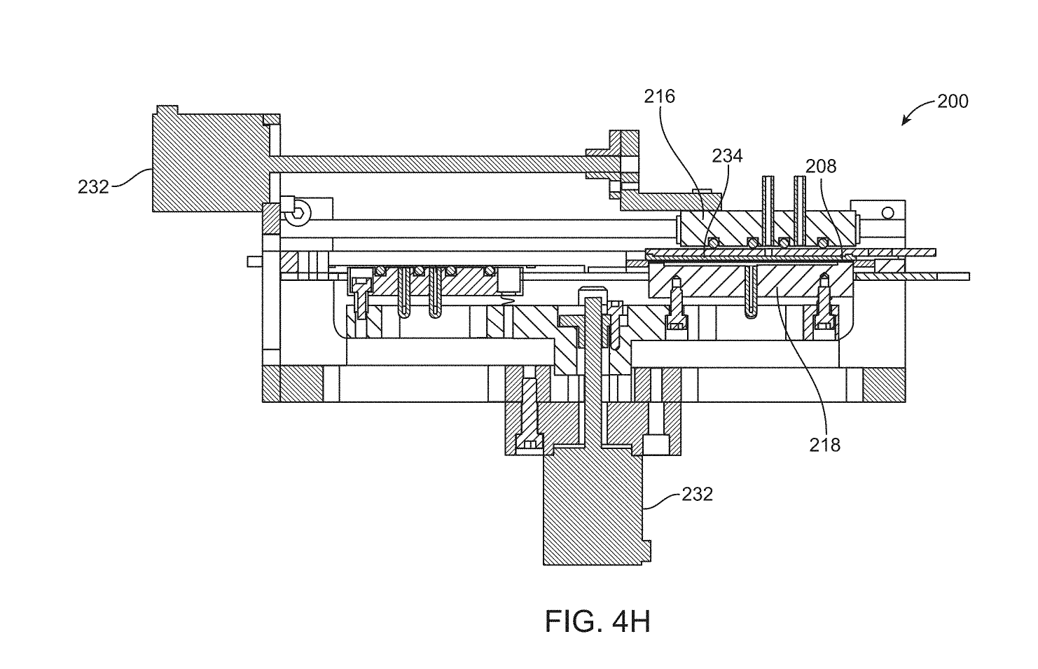

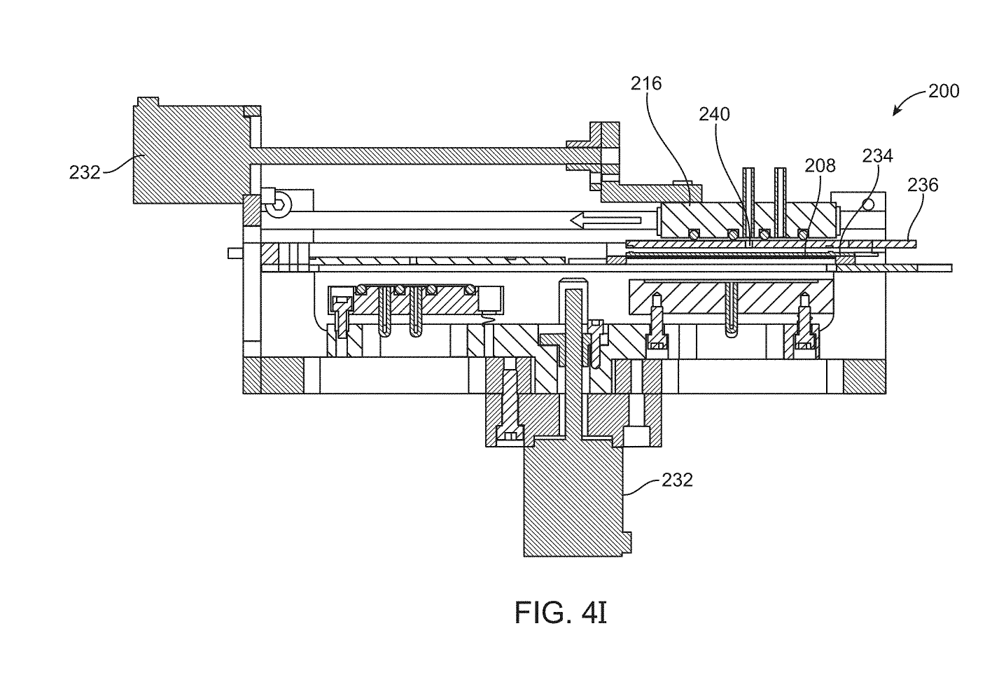

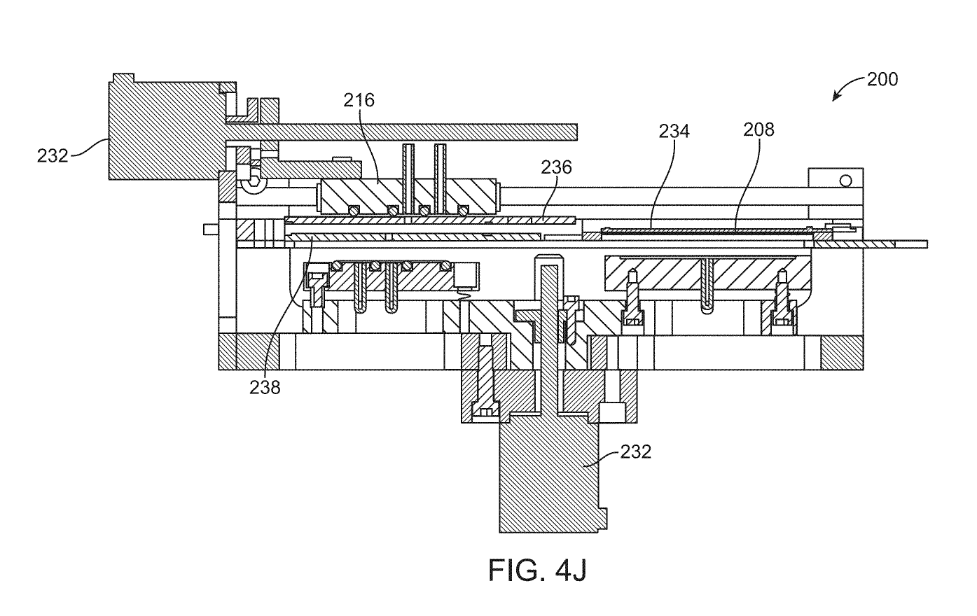

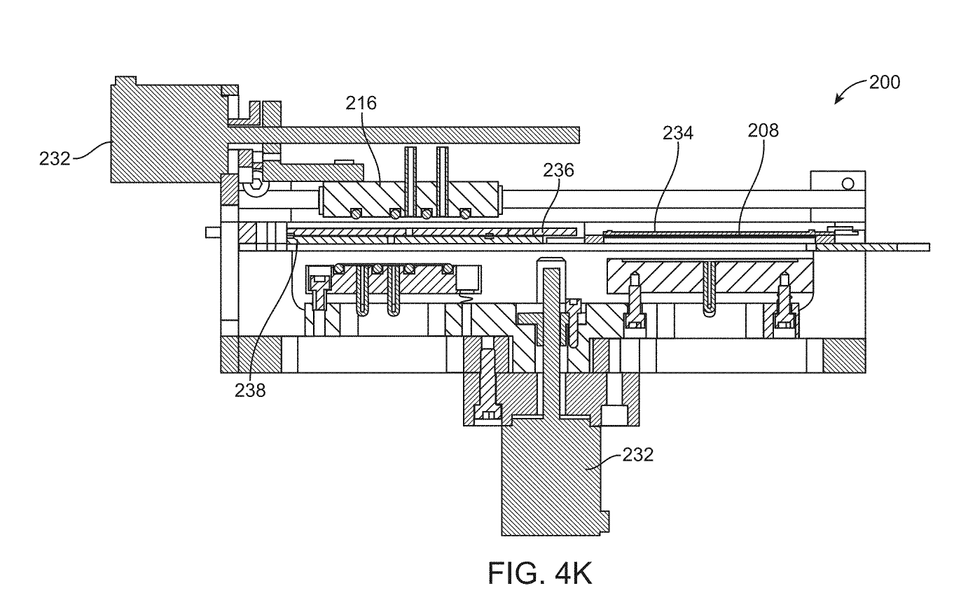

In some embodiments, the gel cassette 106, 206, 306 and a western blotting membrane 108, 208, 308 are placed in a horizontal side-by-side position on rails in a drawer 102, 202 (FIGS. 2A, 4A) and the drawer 102, 202, 302 is inserted into the housing of the cassette opener 100, 200, 300 such that at least one vacuum chuck is positioned above and below the cassette 106, 206, 306 (FIGS. 2A-2F, 4B-4D, 5A).

Next, a first vacuum chuck 114, 214, 314 underneath the plane of the drawer 102, 202, 302 is moved up in the Z direction, mates with the lower wall of the cassette, and pushes the cassette toward the second vacuum chuck 116, 216, 316 (FIGS. 2G, 4E, 5B). In embodiments in which the first and second vacuum chucks have an inner O-ring 126, 226, 326 and an outer O-ring 127, 227, 327, the inner 0-ring 126, 226, 326 in the first and second vacuum chucks forms a seal around the first and second holes in the respective upper and lower walls of the cassette. In embodiments having a third vacuum chuck 118, 218 below the plane of the drawer and in a side-by-side relationship with the first vacuum chuck (FIGS. 2G, 4E), both the first vacuum chuck 114, 214 and the third vacuum chuck 118, 218 are moved together such that when the first vacuum chuck 114, 214 is moved up, the third vacuum chuck 118, 218 is also moved up.

The next step of the method comprises removing one of the walls of the cassette while supporting the gel with the remaining wall.

In an embodiment having four vacuum chucks (FIG. 2H), the gel 134 is first removed from the upper wall 136 by using the second vacuum chuck 116 above the plane of the drawer to inject fluid through the first hole 140 in the upper wall 136 of the cassette while supporting the gel 134 with the lower wall 138. In some embodiments, while the second vacuum chuck 116 is injecting fluid through the first hole 140, the first vacuum chuck 114 can apply a vacuum to the lower wall 138 of the cassette to aid in gel removal. Next, the second and fourth vacuum chucks 116, 120 located above the plane of the drawer move to the left. The second vacuum chuck 116 holds the upper wall 136 of the cassette by vacuum and the fourth vacuum chuck 120 is positioned over the gel 134 (FIG. 2I). The next step of the method comprises vacuum gripping an exposed side of the gel 134 with the fourth vacuum chuck 120 while injecting fluid through the second hole 142 in the lower wall 138 with the first vacuum chuck 114 to remove the gel 134 from the lower wall 138 (FIGS. 2J-2K). In some embodiments, the gel 134 is vacuum gripped in a recess 130 in the fourth vacuum chuck 120. The gel 134 is then moved by the fourth vacuum chuck 120 to a position above the membrane 108 (FIG. 2L) and the second vacuum chuck 116 that is vacuum-gripping the upper wall 136 moves over the lower wall 138 resting on the drawer rails. The first vacuum chuck 114 and a third vacuum chuck 118 below the membrane 108 are moved up so that the first vacuum chuck 114 is supporting the lower wall 138 and the membrane 108 is positioned directly below the gel 134 (FIG. 2M). The vacuum in the second and fourth vacuum chucks 116, 120 is then turned off so that the upper wall 136 of the cassette is placed on the lower wall 138 and the gel 134 is placed on the membrane 108 (FIG. 2N). The membrane 108 with the gel 134 thereon can then be removed from the cassette opener 100 for further processing (e.g., for western blotting) by ejecting the drawer from the housing of the cassette opener. The lower and upper walls 136, 138 of the cassette can also be discarded.

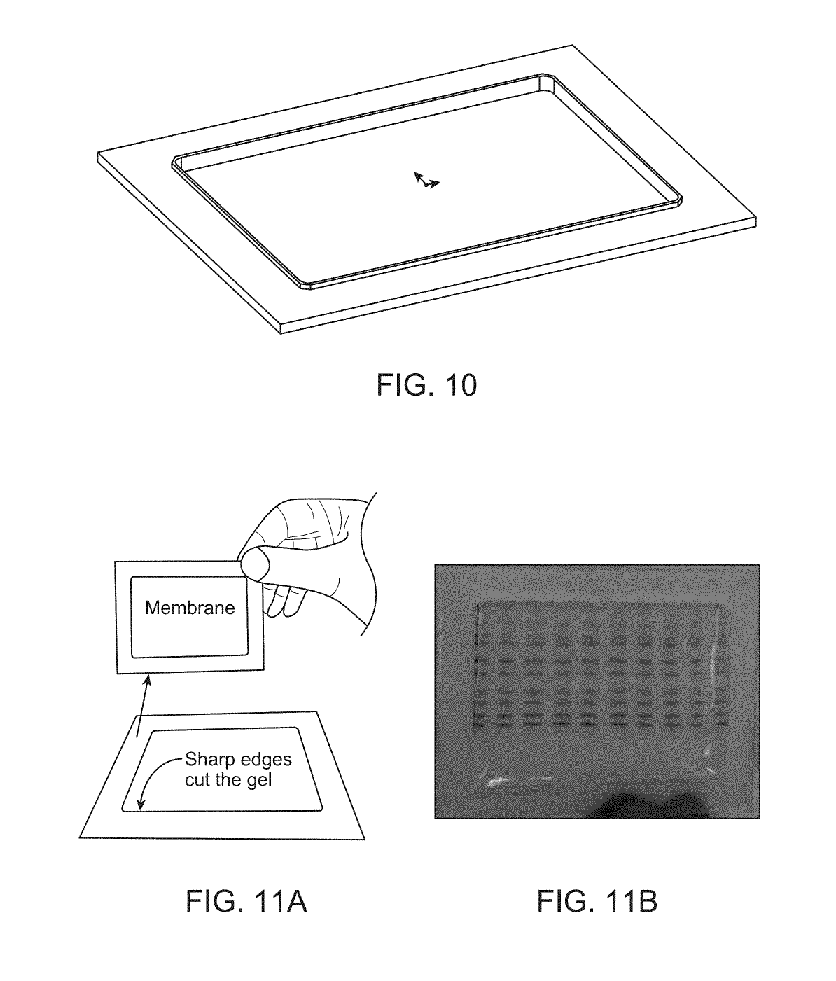

In embodiments having two vacuum chucks (FIGS. 5A-5I) or three vacuum chucks (FIGS. 3-4K), the first vacuum chuck 214, 314 is moved up in the Z direction to press against the lower wall 238, 338 of the cassette and to vacuum grip the lower wall 238, 338 while the second vacuum chuck 216, 316 vacuum grips the upper wall 236, 336 of the cassette. The gel 234, 334 is then removed from the lower wall 238, 338 by injecting fluid with the first vacuum chuck 214, 314 through the second hole 242, 342 in the lower wall 238, 338 of the cassette (FIGS. 4F, 5C). The next step of the method comprises moving the second vacuum chuck 216, 316 to a position above the membrane 208, 308 (FIG. 4G, 5D) while the second vacuum chuck 216, 316 is vacuum gripping the upper wall 236, 336 that has the gel thereon. In some embodiments, a third vacuum chuck 218 below the membrane 208 is moved up so that the membrane 208 is mated with the gel 234 (FIG. 4H). In certain embodiments, the second vacuum chuck 316 moves down to the membrane 308 until an exposed side of the gel 334 is mated with the membrane 308 (FIG. 5E). In some embodiments in which the membrane is mounted to a frame that has raised sharp inner edges (FIG. 10), the sharp edges cut the gel as the membrane is mated with the gel (FIGS. 11A-11B). The gel 234, 334 is then released from the upper wall 236, 336 and is placed onto the membrane 208, 308 by using the second vacuum chuck 216, 316 to inject fluid through the first hole 240, 340 in the upper wall 236, 336 of the cassette (FIGS. 4I, 5E). As the gel 234, 334 is released from the upper wall 236, 336, the upper wall 236, 336 remains vacuum gripped by the second vacuum chuck 216, 316. The upper wall 236, 336 is moved to the left by the second vacuum chuck 216, 316 so that the upper wall 236, 336 is positioned above the lower wall 238, 338 resting on the drawer rails (FIGS. 4J, 5F-5G). In some embodiments (FIG. 5H), the second vacuum chuck 316 moves down in the Z direction until it is close to the lower wall 338. The vacuum in the second vacuum chuck 216, 316 is then turned off to release the upper wall 236, 336 so that the upper wall 236, 336 rests on the lower wall 238, 338 (FIGS. 4K, 5I). The cassette walls can then be discarded and the membrane with the gel thereon can then be removed from the cassette opener for further processing. In some embodiments, the drawer is ejected from the housing of the cassette opener 100 so that the cassette walls and the membrane with the gel thereon can be removed from the drawer.

All patents, patent applications, and other published reference materials cited in this specification are hereby incorporated herein by reference in their entirety.

What is claimed is:

1. A gel cassette opener comprising:
a drawer slidably mounted in a housing and movable in a sliding direction between a first position in which at least a portion of the drawer extends outside a front opening of the housing, and a second position in which the drawer is contained within the housing, wherein the drawer comprises two elongated support rails for supporting a gel cassette and a membrane in a horizontal side-by-side position;
a first and second vacuum chuck movably mounted in the housing, each chuck comprising a planar support having a vacuum aperture and a fluid aperture, wherein the first vacuum chuck is located below the plane of the drawer and the second vacuum chuck is located above the plane of the drawer;
a vacuum source operably connected to the vacuum aperture in each of the vacuum chucks;
a fluid source operably connected to the fluid aperture in each of the vacuum chucks; and
control circuitry for controlling operation of the gel cassette opener.

2. The gel cassette opener of claim 1, further comprising a third vacuum chuck located below the plane of the drawer and movably mounted within the housing.

3. The gel cassette opener of claim 2, further comprising a fourth vacuum chuck located above the plane of the drawer and movably mounted within the housing.

4. The gel cassette opener of claim 3, wherein the fourth vacuum chuck comprises a recess sized such that the margins of the gel rest outside the recess when the fourth vacuum chuck is vacuum gripping the gel.

5. The gel cassette opener of claim 4, wherein the margins are about 1-5 millimeters wide.

6. The gel cassette opener of claim 3, wherein the first, second, third and/or fourth vacuum chucks are moveable in an X, Y, and/or Z direction.

7. The gel cassette opener of claim 4, wherein the recess has a depth of about 0.25-0.75 millimeters.

8. The gel cassette opener of claim 1, wherein the vacuum source is connected to the vacuum aperture by a vacuum channel within each of the vacuum chucks.

9. The gel cassette opener of claim 1, wherein the fluid source is connected to the fluid aperture by a fluid channel within each of the vacuum chucks.

10. The gel cassette opener of claim 1, wherein the fluid is selected from the group consisting of air, nitrogen, water, and oil.

11. A method of opening a gel cassette, the method comprising:
providing a gel cassette comprising a gel sandwiched in between a lower wall and a upper wall;
removing the gel from the lower wall while supporting the gel with the upper wall;
mating an exposed side of the gel to a membrane; and
removing the gel from the upper wall while the gel remains mated to the membrane.

12. The method of claim 11, wherein the removing the gel from the lower wall step comprises injecting the fluid through a second hole in the lower wall.

13. The method of claim 12, further wherein the removing the gel from the upper wall step comprises injecting a fluid through a first hole in the upper wall.

14. The method of claim 13, further comprising applying a vacuum to the gel from below while injecting the fluid through the first hole in the upper wall.

15. The method of claim 13, wherein a plug is removed from the first hole and the second hole prior to injecting the fluid through each of the first and second holes.

16. The method of claim 15, wherein the first hole is located substantially in the center of the upper wall and the second hole is located substantially in the center of the lower wall.

17. The method of claim 11, wherein the membrane is attached to a frame.

18. The method of claim 17, wherein the frame comprises raised sharp inner edges that cut through the gel when pressed against the gel.

19. The method of claim 11, wherein the lower or upper wall of the gel cassette comprises a groove on an inner surface contacting the gel and the groove runs in a continuous line parallel to the edges of the lower or upper wall.

20. The method of claim 11, wherein the lower and upper walls are not attached to each other.
